(19) United States
(12) Patent Application Publication
(10) Pub. No.: US 2014/0125076 A1
(43) Pub. Date: May 8, 2014

(54) APPARATUS(ES) AND METHOD(S) FOR SECURING MOBILE DEVICE(S)

(71) Applicant: Allan Todd Soffer, New York, NY (US)

(72) Inventor: Allan Todd Soffer, New York, NY (US)

(21) Appl. No.: 14/129,217

(22) PCT Filed: Jun. 23, 2012
(86) PCT No.: PCT/US12/43911

§ 371 Date: Dec. 24, 2013

Related U.S. Application Data
(60) Provisional application No. 61/571,300, filed on Jun. 24, 2011.

(51) Int. Cl. H04B 1/38

(52) U.S. Cl. CPC H04B 1/3833
USPC 294/149; 29/428

(57) ABSTRACT

An apparatus designed in dimensions that will make it suitable for affixing to a variety of mobile devices. The device is comprised of a flexible base having anterior and posterior sides and first and second ends, where each end includes first and second slots. Two-slotted tabs are operably coupled to each end, where one end of the two-slotted tab is operably coupled to the first slot, and the other end is operably coupled to the second slot. Affixed to the broadest front surface area by the tabs is an variable length tie. On the opposite broadest surface area, there is an application of adhesive material, heretofore referred to as an “adhesive field”, suitable for releasably adhering the invention to a variety of mobile devices. The backboard may be composed of a first and second layer and a swivel therebetween.

### FIELD OF INVENTION

The present invention relates generally to apparatus(es) and method(s) for securing a device(s) to a user. More specifically, the present invention relates to apparatus(es) and method(s) for securing mobile device(s) to a user's hand.

### BACKGROUND

In recent years, portable electronic devices have enjoyed a sharp climb in popularity. This, in turn, has led to portable electronic devices having in everyday life. However, repeated use over a long period of time may lead to strain on an increasing part the hand or wrist of the user, with some discomfort as a result. Additionally, there is an increased trend of people dropping their mobile devices, often resulting in their damage or destruction. Therefore, there exists a need for a device which allows for securing a portable electronic device in the user's hand, without strain on the wrist or fingers.

### SUMMARY OF THE INVENTION

A first aspect of the invention provides an apparatus for securing a mobile device to a user's hand. The device comprises a flexible base having proximal and distal surfaces and first and second ends, where each end includes first and second slots, and two-slotted tabs operably coupled to each end of a variable length tie. One two-slotted tab is operably coupled to the first slot and the other two slotted tab is operably coupled to the second slot. The distal surface of the flexible base may include an adhesive field for releasably coupling the apparatus to the mobile device, where an interstice is formed between the proximal surface of the flexible base and the variable length tie. Alternatively, the apparatus may comprise a removable cover, having oppositely facing first and second surfaces, where the first surface of the removable cover facing the proximal surface of the flexible base is operably coupled to the proximal surface of the flexible base, and where the second surface of the removable cover includes an adhesive field for releasably coupling the apparatus to the mobile device.

A second aspect of the invention provides a kit for using the previously described apparatus. The distal surface of the flexible base and the posterior of a mobile device are releasably coupled using an adhesive.

A third aspect of the invention provides a method of securing a mobile device to a portion of a user's hand. The method comprises of releasably coupling a mobile device to the previously described apparatus, and inserting at least one finger of a user's hand into the interstice between the variable length tie and the proximal surface of the flexible base.

A fourth aspect of the invention provides an apparatus for securing a mobile device to a user's hand. The apparatus is comprised of a mountable means for releasably adhering a proximal surface of the mountable means to a posterior surface of the mobile device. The mountable means has proximal and distal surfaces and first and second ends, where each end includes first and second points of contact. A portion of the distal surface between the first and second point of contacts is recessed in respect to a remaining portion of the first surface, and where the proximal surface of the mountable means includes an adhesive field for releasably adhering the proximal surface of the mountable means to the posterior surface of the mobile device. Additionally, the device also includes an elastic means for wrapping around a user's hand, and a first and second coupling means for operably coupling each end of the elastic means to the first and second points of contact. Each end of the elastic means is threaded through two parallel slots of each respective coupling means, and the first coupling means is operably coupled to the first point of contact of the mountable means and the second coupling means is operably coupled to the second point contact of the mountable means. An interstice is formed between the distal surface of the mountable means and the elastic means.

### BRIEF DESCRIPTION OF THE DRAWINGS

The features of the invention are set forth in the appended claims. The invention itself, however, will be best understood by reference to the following detailed description of an illustrative embodiment when read in conjunction with the accompanying drawings, wherein:

FIG. 1 depicts an angled elevation view of an apparatus for securing a mobile device to a user's hand, in accordance with embodiments of the present invention; and

FIG. 2 depicts an angled elevation view of a flexible base, in accordance with embodiments of the present invention;

FIGS. 3A-3C depict an a variable length tie having operable couplings, in accordance with embodiments of the present invention;

FIGS. 4A-4C depict an angled elevation view of an apparatus for securing a mobile device to a user's hand, in accordance with embodiments of the present invention;

FIG. 5 a top elevation view of an apparatus having a swivel for securing a mobile device to a user's hand, in accordance with embodiments of the present invention;

FIGS. 6A-6B depict a cross sectional view of the apparatus depicted in FIG. 5, taken along the line 6-6, in accordance with embodiments of the present invention;

FIG. 7 depicts an angled elevation view of an apparatus for securing a mobile device to a user's hand, in accordance with embodiments of the present invention;

FIG. 8 depicts an angled elevation view of an apparatus for securing a mobile device to a user's hand, in accordance with embodiments of the present invention;

FIGS. 9A-9D depict operably coupling a variable length tie to a flexible base, in accordance with embodiments of the present invention;

FIG. 10 depicts a side cross-sectional view taken along the line 2-2 of the apparatus depicted in FIG. 2, in accordance with embodiments of the present invention;

FIG. 11 depicts a method for using the apparatus for securing a mobile device to a user's hand, in accordance with embodiments of the present invention; and

FIG. 12 is a flow diagram depicting the steps 140-143 of a method 139, in accordance with embodiments of the present invention.

### DETAILED DESCRIPTION OF EMBODIMENTS OF THE INVENTION

Definitions:

As used herein, unless otherwise defined, the singular forms “a”, “an”, and “the” include plural references unless the context clearly dictates otherwise. Thus, for example, reference to “a device” includes a plurality of such devices, and so forth.

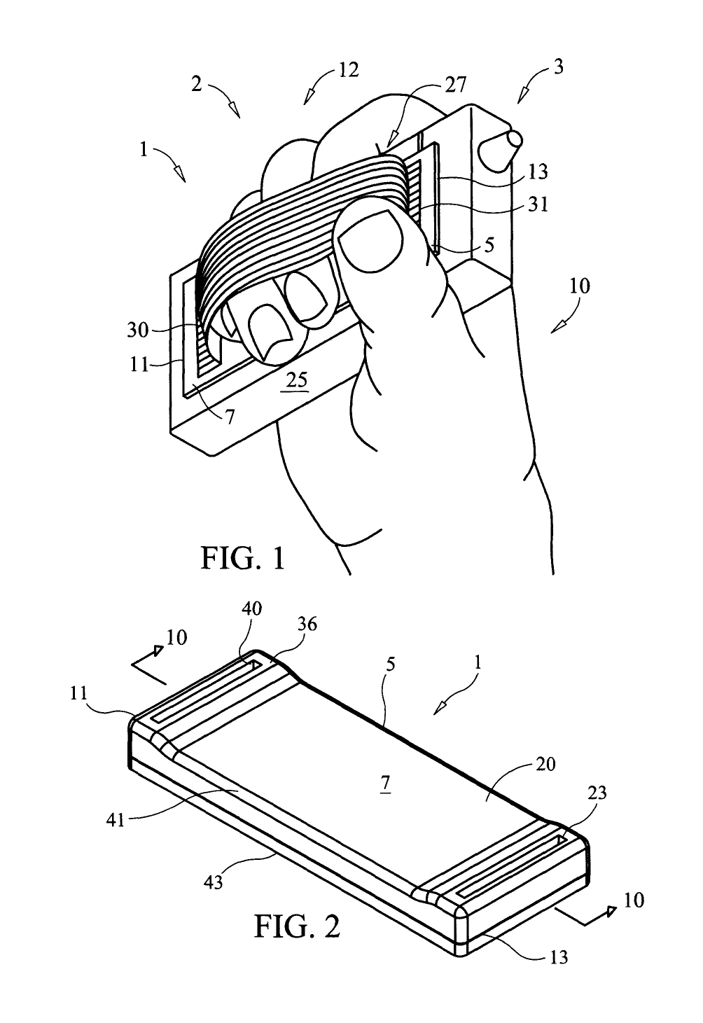

As used herein, unless otherwise defined, the term “releasably coupling” or “releasably coupled” or “releasably joined” is defined as forming or braking or cleaving or severing of a mechanical coupling between the proximal surface 14 of the flexible base 5 and a posterior surface of a mobile device, depicted in FIG. 1 and described in associated text, herein.

As used herein, unless otherwise defined, the term “releasably adhering” or “releasably adhered” is defined as repeatably sticking and unsticking an object such as a posterior surface of a mobile phone to a proximal surface of a flexible base using an adhesive that forms a temporary bond between the objects.

As used herein, unless otherwise defined, the terms ‘distal surface” and “proximal surface” refer to opposite surfaces of the flexible base 5, wherein the proximal surface 14 is closest to a posterior surface 9 of the mobile device 3 and the distal surface 7 is farthest from the posterior surface 9 of the mobile device 3.

As used herein, unless otherwise defined, the term “unitary construction” is defined as being one piece.

As used herein, unless otherwise defined, the term “cam” is defined as a rotating or sliding piece in a mechanical linkage used especially in transforming rotary motion into linear motion or vice-versa.

As used herein, unless otherwise defined, the term “swivel” is defined as a coupling between two parts enabling one to revolve without turning the other.

As used herein, unless otherwise defined, the term “flexible base” is defined as being capable of being bent or flexed; pliable, it's degree of flexibility being inversely proportional to the degree of stress transferred to an adhesive bond or device to which the flexible base may be operably coupled.

As a mobile device owner since the 1990s, the inventor would frequently drop mobile devices. To address this matter, the inventor envisioned and conceived a “security strap” fastened to a backing that could then be adhered to a mobile device and strapped to the finger(s) or hand, thereby rendering the device less likely to be dropped.

This invention is intended as an aftermarket appliance for use with a variety of mobile devices. The invention can be affixed to a variety of mobile devices. The user can pass one or more fingers transversely under a variable length tie, which is fastened to the broadest surface area of the anterior side of the rigid but flexible base, effectively strapping the device to the user's one or more fingers, or in an embodiment of a larger version of this invention, an entire hand.

The present invention disclosed and detailed frees a mobile-device owner from having to clutch the mobile device by the security ensured by having the device strapped to the user's one or more fingers by means of a snug-fitting, variable length tie, fastened to the broadest surface area of the anterior side of a rigid but flexible base. The broadest surface area of the posterior side of the rigid but flexible base is adhered to the mobile device by a self-contained, adhesive field.

To effect its intended use, the user applies the adhesive field located on the broadest surface area of the posterior side of the invention, to a mobile device. To wit: A user has just applied the invention to a mobile device. The user can now insert one or more fingers transversely under the variable length tie, which is fastened to the broadest surface area of the anterior side of the rigid but flexible base. The device is now effectively strapped to the user's one or more fingers.

FIG. 1 depicts an elevation view of an apparatus 1 for securing a mobile device 3 to a user's hand 10. The apparatus 1 comprises: a flexible base 5, a variable length tie 22 between points of contact 30, 31 located in ends 11, 13 of the flexible base 5, and an interstice 27 into which fingers 12, or all of a user's hand 10 may be inserted. The flexible base 5 has a distal surface 7, a proximal surface 14 between the first end 11 and a second end 13. A variable length tie 22 is operably coupled to ends 11, 13 of the flexible base 5 at the points of contact 30, 31. The variable length tie 22 may be operably coupled to the contact points 30, 31 using adhesive, e.g. silicone adhesive, acrylic adhesive or the like. The variable length tie 22 may be an elastic strap, an elastic band, an elastic cord, velcro straps, or variable length belts with buckles. A portion of the distal surface 7 between the points of contact 30, 31 for the variable length tie 22 is recessed 20 in respect to a remaining portion 36 of the distal surface 7. In one embodiment, a proximal surface 14 of the flexible base 5 of the apparatus 1 includes an adhesive field 19 for releasably adhering the invention to a variety of mobile devices 3. A user may insert his fingers 12 or his whole hand 10 into interstice 27 formed between a broadest surface area of the distal surface 7 of the flexible base 5 and the variable length tie 22, further securing his grip onto the mobile device 3.

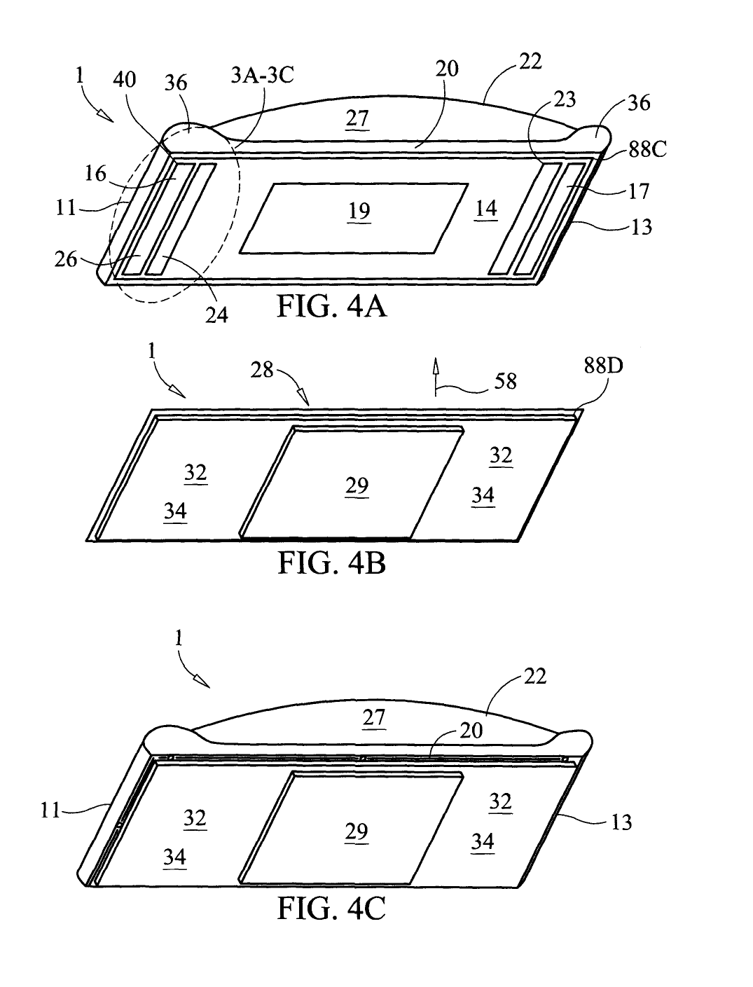

Alternatively, the apparatus 1 comprises a removable cover 32, having oppositely facing first 28 and second surfaces 34, depicted in FIG. 4B, and described in associated text, infra. The first surface 28 facing the proximal surface 14 of the flexible base 5 is operably coupled to the proximal surface 14 of the flexible base 5, as depicted in FIG. 4C, and described in associated text, infra. The second surface 34 of the removeable cover 32 includes an adhesive field 29 for releasably coupling the apparatus 1 to the mobile device 3.

FIG. 1 depicts a kit 2 for coupling the apparatus 1 to a mobile device 3. The kit 2 comprises the apparatus 1 and a mobile device 3 with a posterior surface 9 of a mobile device 3, and releasably coupling the devices using an adhesive.

In an embodiment, an apparatus 1 for securing a mobile device 3 to a user's hand 10 is comprised of a flexible base 5 for releasably adhering a proximal surface 14 of the flexible base 5 to a posterior surface 9 of the mobile device 3. The flexible base 5 has proximal and distal surfaces 7, 14 with first and second ends 11, 13. Each end of has first and second points of contact 30, 31. A portion of the distal surface 7 between the first and second points of contact 30, 31 is recessed in respect to a remaining portion of the distal surface 7. The proximal surface 14 of the flexible base 5 includes an adhesive field 19 for releasably adhering the proximal surface 14 of the flexible base 5 to the posterior surface 9 of the mobile device 3. A variable length tie 22 for wrapping around a user's hand 10 is operably coupled to the first and second points of contact 30, 31 by the first and second slots 23, 40. An interstice 27 is thus formed between the distal surface 7 of the flexible base 5 and the variable length tie 22.

FIG. 2 depicts an elevation view of an embodiment of the flexible base 5 of the apparatus 1. The flexible base 5 has a distal surface 7 between the first end 11 and a second end 13. The first end 11 and the second end 13 include a first slot 40 and a second slot 23 respectively. A recessed portion 20 of the distal surface 7 is between the first and second ends 11, 13 with respect to a remaining portion 36 of the distal surface 7.

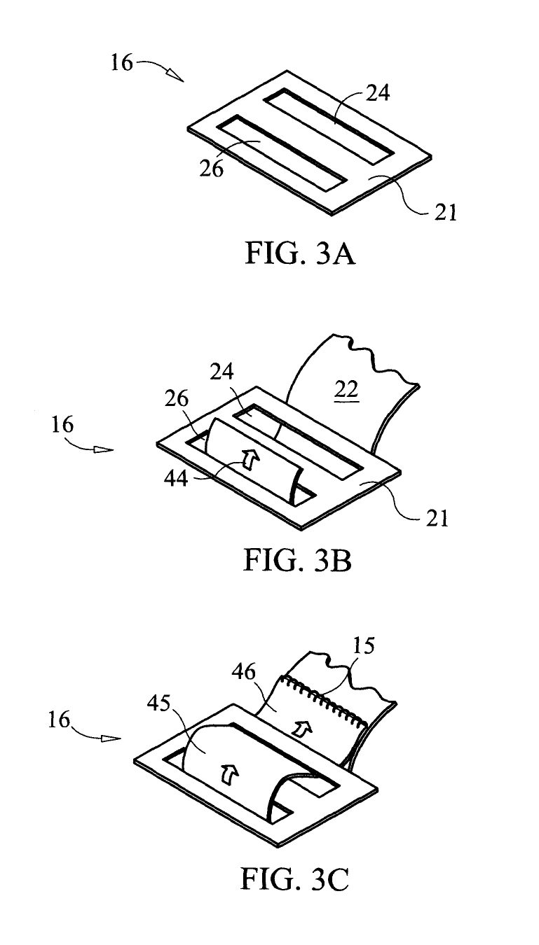

FIGS. 3A-3C depict a side elevation view of an operable coupling 16, 17, comprising, an variable length tie 22 in the process of being threaded through first and second slots 26, 24 of a two-slotted tab 21.

FIG. 3A depicts the operable coupling 16, 17 of two slotted tab 21. The two slotted tab 21 has a first slot 26, and a second slot 24. In FIG. 3B the variable length tie 22 has been inserted into the first slot 26 of the tab, as indicated by the directional arrow 44. The variable length tie 22 has been also threaded through the second slot 24, as indicated by directional arrow 45 in FIG. 3c. The variable length tie 22 also has been doubled back upon itself as indicated by directional arrow 46, and operably coupled at a point of intersection 15.

FIG. 4A depicts an elevation view of an apparatus 1 for securing a mobile device 3 to a user's hand. In an embodiment, the apparatus 1 is comprised of a flexible base 5 having a proximal surface 14, and a distal surface 7 with first and second ends 11, 13. Each end 11, 13 has slots 40, 23, through which an operable coupling 16, 17 has been fitted. The proximal surface 14 includes an adhesive field 19 for releasably adhering the apparatus 1 to a variety of mobile devices 3. In an embodiment, a recessed groove 18 extends along a perimeter of the proximal surface 14 of the flexible base 5. The recessed groove 18 forms four corners in the proximal surface 14 of the flexible base 5, one of which is 88c.

FIG. 4B depicts a cross-sectional view of a removable cover 32. The removable cover 32 comprises a first surface 28 and a second surface 34. The second surface 34 has an adhesive field 29. In an embodiment of the apparatus 1, a recessed groove 18 has been inset into the distal surface 7 of the flexible base 5. The first surface 28 of the removable cover 32 faces the proximal surface 14 of the flexible base 5, so the first surface 28 of the removable cover 32 may be frictionally coupled to the proximal surface 14 of the flexible base 5 by inserting the first surface 28 of the removable cover 32 along its perimeter into the recessed groove 18. The removable cover 32 may have any solid shape, e.g. a rectilinear solid or a disc shape, so long as the removable cover 32 is able to insert into the recessed groove 18.

FIG. 4C depicts the apparatus 1 after the removable cover 32 has been moved in the direction of the arrow 58 as shown in FIG. 2b and inserted in a recessed groove 18 around the perimeter of the proximal surface 14 of the flexible base 5. Each corner of the flexible base 5 is aligned with the respective corner of the removable cover 32 so that the corner 88d of the removable cover 32, as shown in FIG. 4C, is aligned with the corner 88c as shown in FIG. 4A, after the removable cover 32 has been inserted into the groove 18.

In one embodiment, the second surface 34 of the removable cover 32 has an adhesive field 29 that allows it to operably couple to the mobile device 3. The second surface 34 of the removable cover 32 is in this embodiment facing the posterior side 9 of the mobile device 3.

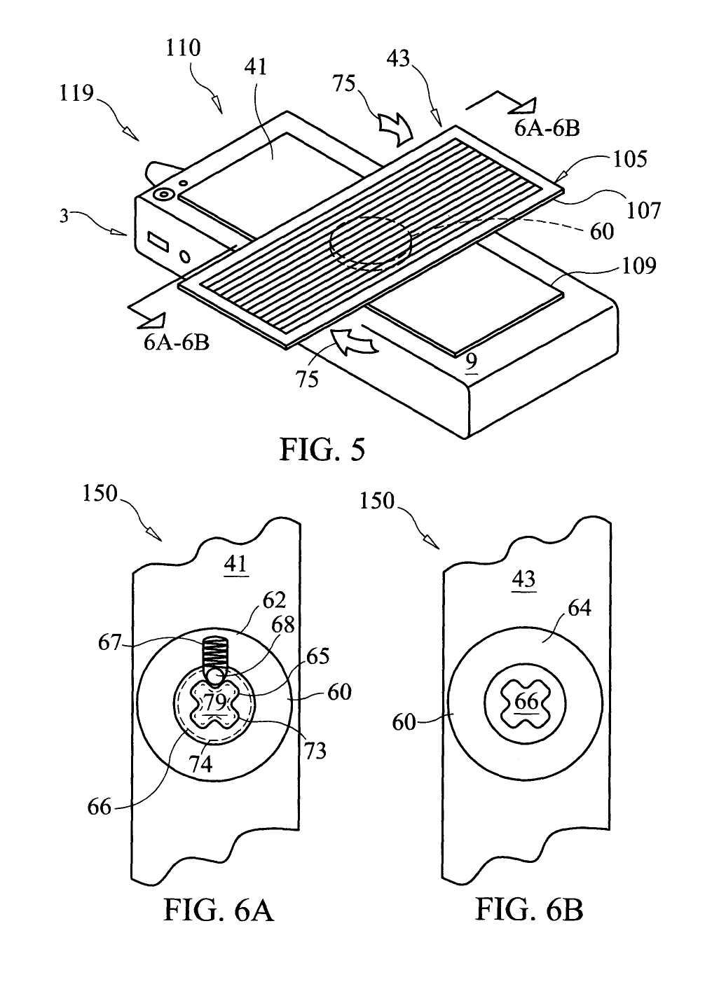

FIG. 5 depicts a side elevation view of an apparatus 1 for securing a mobile device 3 to a user's hand 10. In an embodiment of the apparatus 1, the flexible base 5 comprises a first layer 41 and a second layer 43 and a swivel 60 between them. The swivel 60 is selected from a group consisting of a ball and socket swivel, a friction filling in a slotted groove, and a cam swivel.

FIGS. 6A-6B depicts an exploded cross-sectional view of the swivel 60 taken along the line 6A-6B in FIG. 5. The apparatus 1 for securing a mobile device 3 to a user's hand 10 comprises a flexible base 105 having a first layer 41, and a second layer 43, and the swivel 60, between the first layer 41, and the second layer 43. In an embodiment, the swivel 60 is comprised of a male portion 64 and a female portion 62. The male portion 64 comprises either the first or second layer 41, 43 of the flexible base 5, and an irregular cylindrical surface 73 which seamlessly elaborates a cam 66. The female portion 62 comprises a cylindrical cavity 79 in the opposite layer of the flexible base 105 from the male portion 64, and a reciprocatably and slidably displaceable bearing ball 68 in a housing 67. The reciprocatable and slidably displacable bearing ball 68 undergoes radial displacement in the housing 67 by rolling along a first surface 71 of the cam 66 whenever the cam 66 undergoes axial rotation in the direction of the arrow 75. This allows the first layer 41 to have 360 degrees of rotational freedom with respect to the second layer 43 in an axial plane along the line 6A-6B between the first and second layers 41, 43, when the male portion 64 is inserted into the female portion 62, as shown in FIG. 5.

In an embodiment, the cam 66 has a plurality of radially disposed cam recesses 37 between radially disposed cam lobes 65. This allows the cam 66 to rotatably swivel, then stop rotating as the reciprocating bearing ball 68 moves from one recess 37 to another.

In an embodiment, the swivel 60 is comprised of a cylindrical cavity 79 in either the first layer 41 or the second layer 43 of the flexible base 5, and a cam 66 within it, where the cam 66 is operably coupled to one of the first or second layers 41, 43, and a reciprocating bearing ball 68 slidably displaceable in a spring loaded housing 67. The reciprocating bearing ball 68 undergoes linear displacement in the housing 67 by rolling along a first surface 71 of the cam 66 when the cam 66 undergoes axial rotation, so the first layer 41 to have 360 degrees of rotational freedom with respect to the second layer 43 in an axial plane 6 between the first and second layers 41, 43.

In an embodiment, the cam 66 has a plurality of radially disposed cam recesses 37 between radially disposed cam lobes 65. This allows the cam 66 to rotatably swivel, then stop rotating as the reciprocating bearing ball 68 moves from one recess 37 to another.

In an embodiment, the flexible base 5 is made from a material selected from the group consisting of epoxy resins, unsaturated polyester resins, vinyl ester resins, thermoset polyurethane resins, phenol-formaldehyde resins (phenolic resins), polyimide resins, silicone resins, crosslinked thermoplastic resins, e.g., cross linked polyethylene resins, cross linked polypropylene resins, and cross linked polyvinyl chloride resins.

Alternatively, the flexible base 5 may be made of any flexible material that allows the base to flex under stress, thus avoiding subjecting the adhesive bond between the proximal surface 14 of the flexible base 5 and the posterior surface 9 of the mobile device 3. A flexible base 5 may be advantageously flexed, for example, when used during exercise or strenuous activity, when coupled to a mobile device, without putting stress on the posterior surface 9 of the mobile device 3.

In an embodiment, the adhesive used to releaseably couple the proximal surface 14 of the flexible base 5 to a posterior surface 9 of a mobile device 3 is an acrylic foam tape.

In an embodiment, the mobile device 3 is an electronic tablet. The user then inserts his entire hand 10 into the interstice 27 between the variable length tie 22 and the distal surface 7 of the flexible base 5.

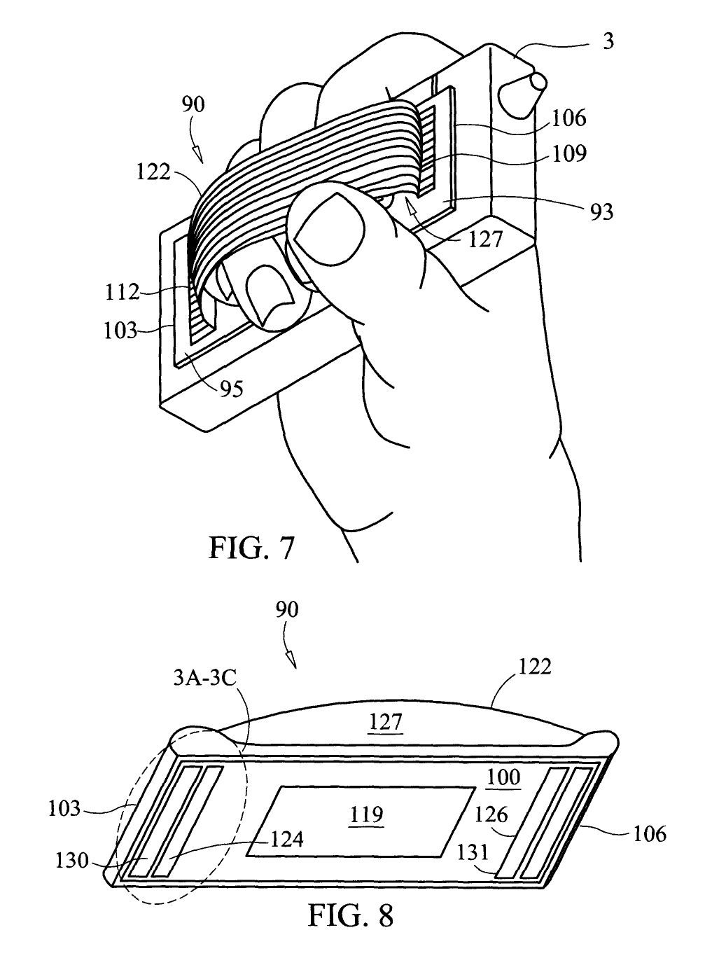

FIG. 7 depicts an elevation view of an apparatus 90 for securing a mobile device 3 to a user's hand 10. The apparatus 90 comprises a mobile device 3, a flexible base 93, a variable length tie 122 between points of contact 109, 112, and an interstice 27 into which fingers 12, or all of a user's hand 10 may be inserted. An apparatus 1 for securing a mobile device 3 to a user's hand 10 has a flexible base 93 for releasably adhering a second surface 100 of the flexible base 93 to a posterior surface 9 of the mobile device 3. The flexible base 93 has a first surface 95 with first and second ends 103 106, and a second surface 100. Each end 103, 106 of the first surface 95 includes first and second points of contact 109 112. A portion of the first surface 95 between the first and second point of contacts 109 112 is recessed in respect to a remaining portion of the first surface 95. The second surface 100 of the flexible base 93 includes an adhesive field 119 for releasably adhering the second surface 100 of the flexible base 93 to the posterior surface 9 of the mobile device 3. The apparatus 1 also includes an elastic means 122 for wrapping around a user's hand 10, as well as a first and second coupling means 130 131 for operably coupling each end of the elastic means 122 to the first and second points of contact 109 112. An interstice 127 is formed between the first surface 95 of the flexible base 93 and the elastic means 122.

FIG. 8 depicts an angled elevation view of the posterior side of the apparatus. In an embodiment, each end of the elastic means 122 is threaded through a two-slotted tab 21 having a first slot 126, and a second slot 124. The first coupling means 130, is operably coupled to the first point of contact 109 of the flexible base 93, and the second coupling means 131 is operably coupled to the second point of contact 112 of the flexible base 93.

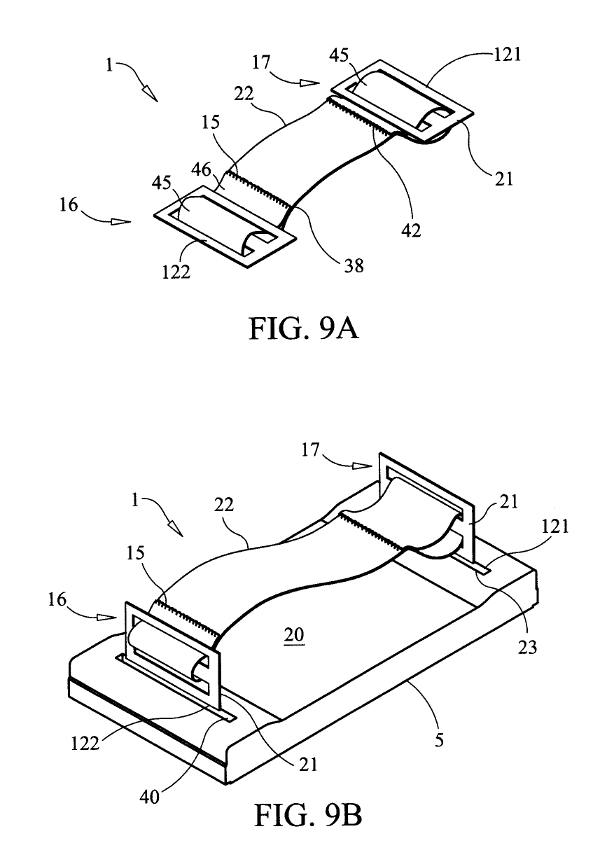

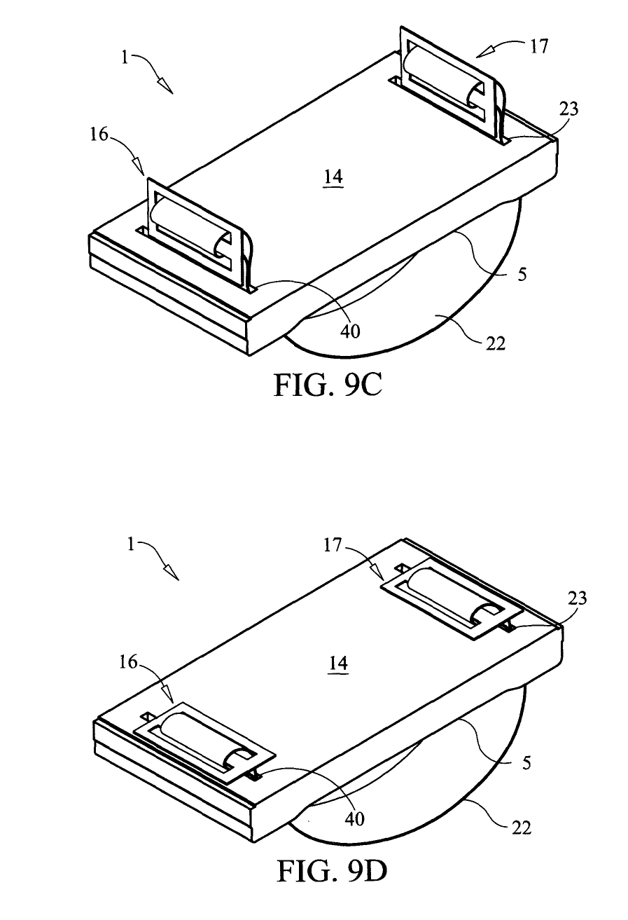

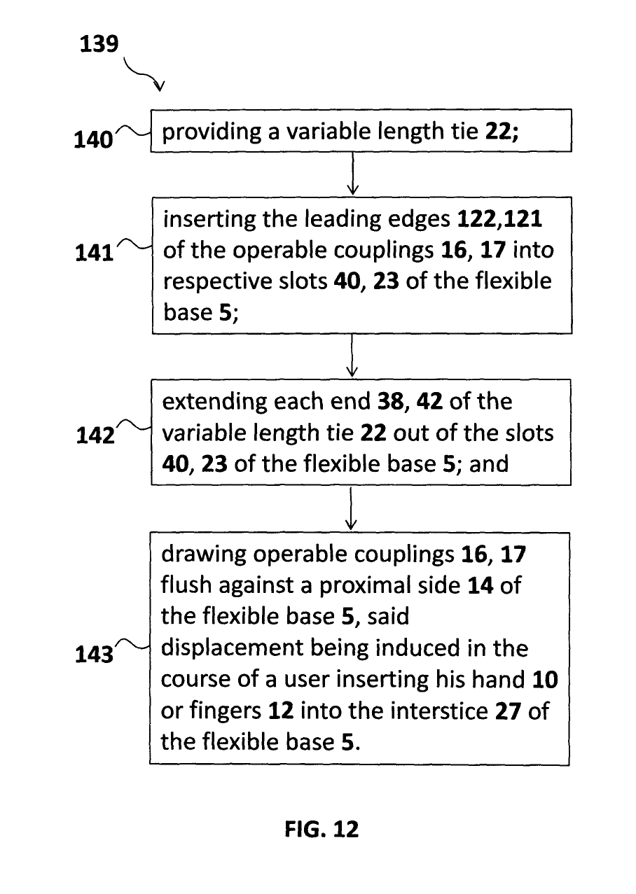

FIGS. 9a-d depict the apparatus 1 after steps 140-143 of a method 139 of operably coupling the variable tie 22 to the flexible base 5. FIG. 12 is a flow diagram depicting the steps 140-143 of a method 139.

FIG. 9A depicts a first step 140, providing a variable length tie 22. The variable length tie 22 comprises operable couplings 16, 17, coupling 16 being proximal to end 38 and coupling 17 being proximal to end 42. Couplings 16 and 17 each comprise a two slotted tab 21 through which an end 38, 42 has been threaded, depicted in FIGS. 3A-3C, and described in associated text, herein. Coupling 16 has leading edge 122, and coupling 17 has leading edge 121.

FIG. 9B depicts a second step 141 of the method 139, inserting the leading edges 122,121 of the operable couplings 16, 17 into respective slots 40, 23 of the flexible base 5.

FIG. 9c depicts a third step 142 of the method 139 where the leading edges 122, 121 of the operable couplings 16, 17 have been inserted into respective slots 40, 23 of the flexible base 5, and each end 38, 42 of the variable length tie 22 extend out of the slots 40, 23 of the flexible base 5.

FIG. 9d depicts a fourth step 143 of the method 139 where the operable couplings 16, 17 have been drawn flush against the proximal side 14 of the flexible base 5, said displacement being induced in the course of a user inserting his hand 10 or fingers 12 into the interstice 27 of the flexible base 5. The operable couplings 16, 17 rotate out of the plane of the slots 40, 23 and becomes parallel with the plane of the surface 14 when the variable length tie 22 may be drawn back through the respective slots 40, 23 of the flexible base 5 in the course of a user inserting his hand 10 or fingers 12 into the interstice 27 of the flexible base 5.

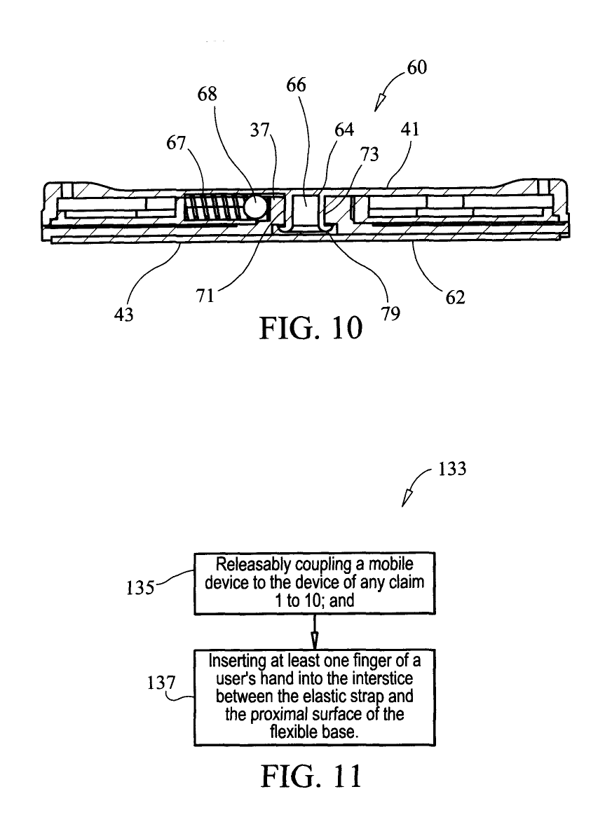

FIG. 10 depicts a cross-sectional view of a first layer 41 and a second layer 43 of an apparatus 1 for securing a mobile device to a user's hand, and the swivel 60 between them, as shown along the line 10-10 in FIG. 2. In an embodiment, the swivel 60 is comprised of a male portion 64 and a female portion 62. The male portion 64 comprises either the first or second layer 41, 43 of the flexible base 5, and an irregular cylindrical surface 73 which seamlessly elaborates a cam 66. The female portion 62 comprises a cylindrical cavity 79 in the opposite layer of the flexible base from the male portion 64, and a reciprocatably and slidably displaceable bearing ball 68 in a housing 67. The reciprocatable and slidably displacable bearing ball 68 undergoes radial displacement in the housing 67 by rolling along a first surface 71 of the cam 66 whenever the cam 66 undergoes axial rotation 75. This allows the first layer 41 to have 360 degrees of rotational freedom with respect to the second layer 43 in an axial plane 6 between the first and second layers 41, 43, when the male portion is inserted into the female portion, as shown in FIG. 5.

In an embodiment, the cam 66 has a plurality of radially disposed cam recesses 37 between radially disposed cam lobes 65. This allows the cam 66 to rotatably swivel, then stop rotating as the reciprocating bearing ball 68 moves from one recess 37 to another.

FIG. 11 depicts a flow diagram listing the steps 135-137 of a method 133 of securing a mobile device 3 to a portion of a user's hand 10 comprising a step 135: releasably coupling a mobile device 3 to the apparatus 1 and a step 137: inserting at least one finger 12 of the user's hand 10 into the interstice 27 between the variable length tie 22 and the distal surface 7 of the flexible base 5, 93.

In an embodiment, the mobile device 3 is an electronic tablet. The user then inserts his entire hand 10 into the interstice 27 between the variable length tie 22 and the distal surface 7 of the flexible base 5.

An Apparatus And Method For Securing Mobile Devices is described above. Various details of the invention may be changed without departing from its scope. Furthermore, the foregoing description of the preferred embodiment of the invention and best mode for practicing the invention are provided for the purpose of illustration only and not for the purpose of limitation.

I claim:

1. An apparatus for securing a mobile device to a user's hand, comprising:
a flexible base having a proximal surface, a distal surface, a first end and a second end, wherein the first end and the second end include a first and a second slot respectively; and
two-slotted tabs operably coupled to each end of a variable length tie, wherein one of the two-slotted tab is operably coupled to the first slot and the other two slotted tab is operably coupled to the second slot;
wherein either the distal surface of the flexible base includes an adhesive field for releasably coupling the apparatus to the mobile device, and wherein an interstice is formed between the proximal surface of the flexible base and the variable length tie, or
wherein the apparatus comprises a removable cover, having oppositely facing first and second surfaces, wherein the first surface of the removable cover facing the proximal surface of the flexible base is operably coupled to the proximal surface of the flexible base,
wherein the second surface of the removable cover includes an adhesive field for releasably coupling the apparatus to the mobile device.

2. The apparatus of claim 1, wherein a recessed groove has been inset into the distal surface of the flexible base, wherein the second surface of the removable cover faces the distal surface of the flexible base, so the second surface of the removable cover may be frictionally coupled to the distal surface of the flexible base by inserting the second surface of the removable cover along its perimeter into the recessed groove.

3. The apparatus of claims 1, wherein the flexible base comprises a first and second layer and a swivel therebetween, and wherein the swivel is selected from the group consisting of a ball and socket swivel, a friction fitting in a slotted groove, and a cam swivel.

4. The apparatus of claim 3, the cam swivel comprising:
a male portion, comprising, either
the first or second layer of the flexible base, an irregular cylindrical surface of which seamlessly elaborates a cam; and
a female portion, comprising:
a cylindrical cavity in the other layer of the flexible base; and
a reciprocatably and slidably displacable bearing ball in a housing,
wherein the reciprocatably and slidably displacable bearing ball undergoes radial displacement in the housing by rolling along a first surface of the cam, when the cam undergoes axial rotation, so the first layer has 360 degrees of rotational freedom with respect to the second layer in an axial plane between the first and second layers, when the male portion is inserted into the female portion.

5. The apparatus of claim 4, wherein the cam has a plurality of radially disposed cam lobes and recesses therebetween, and wherein the cam swivel rotatably swivels, then stops rotating, in conjunction with the reciprocating ball bearing moving from one slot to an adjacent slot.

6. The apparatus of claim 3, the cam swivel comprising:
a cylindrical cavity in either the first layer or the second layer of the flexible base, and a cam therein,
wherein the cam is operably coupled to one of the first and second layers;
a reciprocating bearing ball slidably displacable in a spring loaded housing,
wherein the reciprocating bearing ball undergoes linear displacement in the housing by rolling along a first surface of the cam, when the cam undergoes axial rotation, so the first layer has 360 degrees of rotational freedom with respect to the second layer in an axial plane between the first and second layers.

7. The apparatus of claim 6, wherein the cam has a plurality of cam slots between radially disposed cam teeth, and wherein the cam swivel rotatably swivels, then stops rotating, in conjunction with the reciprocating ball bearing moving from one slot to an adjacent slot.

8. The apparatus of claims 1, wherein the flexible base is made from a material selected from the group consisting of epoxy resins, unsaturated polyester resins, vinyl ester resins, thermoset polyurethane resins, phenol-formaldehyde resins (phenolic resins), polyimide resins, silicone resins, crosslinked thermoplastic resins, e.g., cross linked polyethylene resins, cross linked polypropylene resins, and cross linked polyvinyl chloride resins.

9. The apparatus of claims 1, wherein the adhesive used to releasably couple the distal surface of the flexible base to a posterior surface of the mobile device is an acrylic foam tape.

10. A kit, comprising;
the device of any claim 1 through 9; and
a mobile device, having a posterior surface, wherein the distal surface of the flexible base and the posterior of the mobile device are releasably coupled using an adhesive.

11. A method of securing a mobile device to a portion of a user's hand, comprising:
releasably coupling a mobile device to the device of any claim 1 through 10; and
inserting at least one finger of a user's hand into the interstice between the variable length tie and the proximal surface of the flexible base.

12. The method of claim 12, wherein the mobile device is a tablet, wherein the user inserts his whole hand into the interstice between the variable length tie and the proximal surface of the flexible base.

13. An apparatus for securing a mobile device to a user's hand, comprising:
a mountable means for releasably adhering a proximal surface of the mountable means to a posterior surface of the mobile device,
wherein the mountable means has a proximal surface a distal surface a first end and a second end,
wherein the first and second ends include first and second points of contact,
wherein a portion of the distal surface between the first and second points of contact is recessed in respect to a remaining portion of the second surface, and
wherein the proximal surface of the mountable means includes an adhesive field for releasably adhering the proximal surface of the mountable means to the posterior surface of the mobile device;
an elastic means for wrapping around a user's hand; and
a first and second coupling means for operably coupling each end of the variable length tie to the first and second points of contact,
wherein each end of the elastic means is threaded through two parallel slots of each respective coupling means, and the first coupling means is operably coupled to the first point of contact of the mountable means and the second coupling means is operably coupled to the second point contact of the mountable means, and
wherein an interstice is formed between the distal surface of the mountable means and the elastic means.

14. The apparatus of claim 13, wherein the elastic means is a variable length tie selected from the group consisting of an elastic strap, an elastic band, an elastic cord, velcro straps, and variable length belts with buckles.
